(19) United States
(12) Patent Application Publication
(10) Pub. No.: US 2014/0202401 A1
(43) Pub. Date: Jul. 24, 2014

(54) HYDROGEN ASSISTED COMBUSTION ENGINE SYSTEM FOR A MOTOR VEHICLE

(71) Applicant: Huan-Hsin Kuo, Taipei City (TW)

(72) Inventor: Huan-Hsin Kuo, Taipei City (TW)

(21) Appl. No.: 13/748,855

(22) Filed: Jan. 24, 2013

(51) Int. Cl. F02B 43/10

(52) U.S. Cl. CPC F02B 43/10
USPC 123/3

(57) ABSTRACT

A hydrogen assisted combustion engine system for a motor vehicle includes: an engine having an intake; an air filter; an inlet duct interconnecting the intake and the air filter; a throttle valve disposed in the inlet duct between the intake and the air filter; a hydrogen generator for generating a hydrogen-containing gas; a pump connected to the hydrogen generator and the inlet duct for pumping the hydrogen-containing gas from the hydrogen generator into the inlet duct; and a speed controller electrically connected to the pump and manually operative for adjusting a speed of the pump.

### BACKGROUND OF THE INVENTION

1. Field of the invention

This invention relates to a hydrogen assisted combustion engine system for a motor vehicle, more particularly to a hydrogen assisted combustion engine system including a hydrogen generator and a pump for drawing a hydrogen-containing gas generated from the hydrogen generator into an engine.

2. Description of the related art

U.S. Pat. No. 5,494,538 discloses a hydrogen generation system that includes a magnesium mixture capable of inducing generation of hydrogen when reacting with water in the presence of a chlorine-containing salt.

A motor vehicle normally includes an engine with a cylinder and a piston movably disposed in the cylinder, and an air intake system with a throttle valve for supplying a desired amount of atmospheric air into the cylinder. During an air intake stroke of the engine, the piston descends from a top end to a bottom end of the cylinder to result in a vacuum in the cylinder so that the atmospheric air is forced by atmospheric pressure to flow through the throttle valve and an air intake valve and into the cylinder. An opening of the throttle valve is adjustable for controlling a flow rate of the atmospheric air flowing into the engine in accordance with the engine speed.

U.S. Pat. No. 6,912,977 discloses an apparatus for supplying a hydrogen-containing gas mixture for use in hydrogen assisted combustion in an engine. The hydrogen-containing gas mixture is generated by an electrolysis cell. The apparatus includes an air inlet, a hydrogen inlet, a mixing chamber for generating a fuel mixture from air and hydrogen introduced respectively from the air inlet and the hydrogen inlet, and a control means for controlling air flow through the mixing chamber. The control means includes a volume control of a butterfly valve and an air speed control for varying an effective cross-section of the airflow through the mixing chamber, and is preferably in the form of an annular collar arranged in the mixing chamber for radial expansion or contraction. The aforesaid patent also discloses that a higher amount of hydrogen is required when the engine is operated under a lower speed so as to obtain a higher reduction of fuel consumption.

Although the aforesaid patent does not express the followings explicitly, it may be reasonably inferred based on the whole disclosure of the aforesaid patent that the hydrogen-containing gas mixture and the atmospheric air are drawn into the mixing chamber as a result of an intake stroke of the engine and that in the meantime, the speed of the air flow in the mixing chamber, which is controlled by the butterfly valve and the annular collar, further controls the amount of the hydrogen-containing gas mixture drawn into the mixing chamber during the intake stroke of the engine.

### SUMMARY OF THE INVENTION

An object of the present invention is to provide a hydrogen assisted combustion engine system for a motor vehicle that includes a pump and a speed controller which are useful to ensure stable generation of hydrogen-containing gas and to prevent braking difficulty or requirement of an increased stopping distance when the motor vehicle is driven to move downhill.

According to the present invention, there is provided a hydrogen assisted combustion engine system for a motor vehicle. The hydrogen assisted combustion engine system comprises: an engine having an intake; an air filter; an inlet duct interconnecting the intake and the air filter; a throttle valve disposed in the inlet duct between the intake and the air filter; a hydrogen generator for generating a hydrogen-containing gas; a pump connected to the hydrogen generator and the inlet duct for pumping the hydrogen-containing gas from the hydrogen generator into the inlet duct; and a speed controller electrically connected to the pump and manually operative for adjusting a speed of the pump so as to permit adjustment of an amount of the hydrogen-containing gas from the hydrogen generator into the inlet duct when the motor vehicle is driven to move.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of a hydrogen assisted combustion engine system according to the present invention;

FIG. 2 is a sectional view of a hydrogen generator of the hydrogen assisted combustion engine system of the preferred embodiment; and

FIGS. 3 and 4 are schematic views illustrating how the preferred embodiment is installed on a motor vehicle.

### DETAILED DESCRIPTION OF THE PREFERRED EMBODIMENT

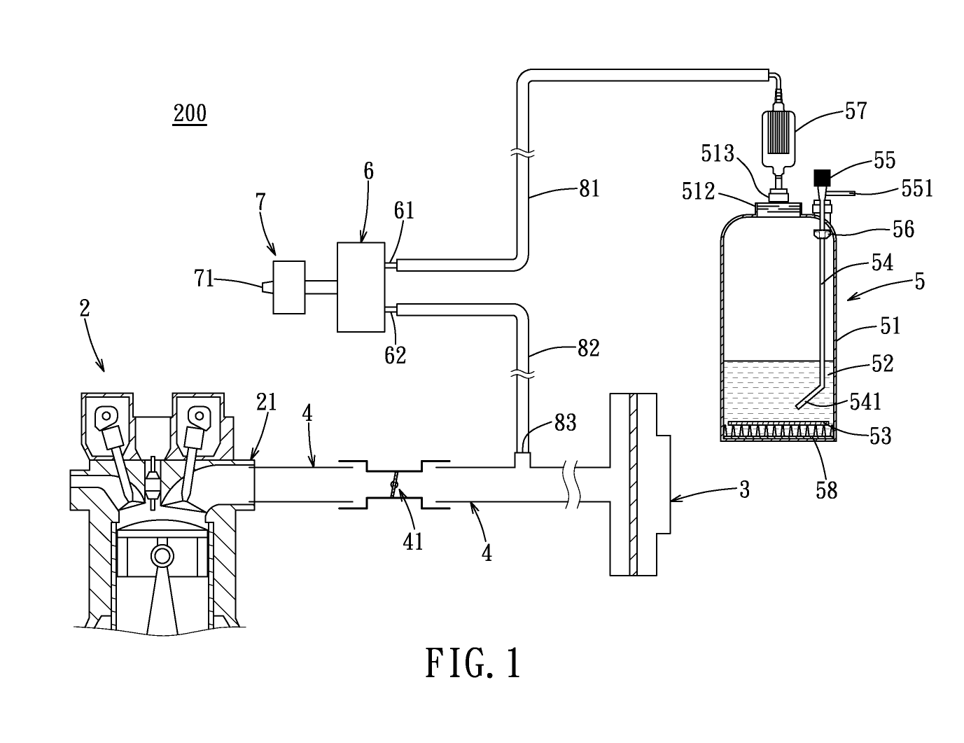

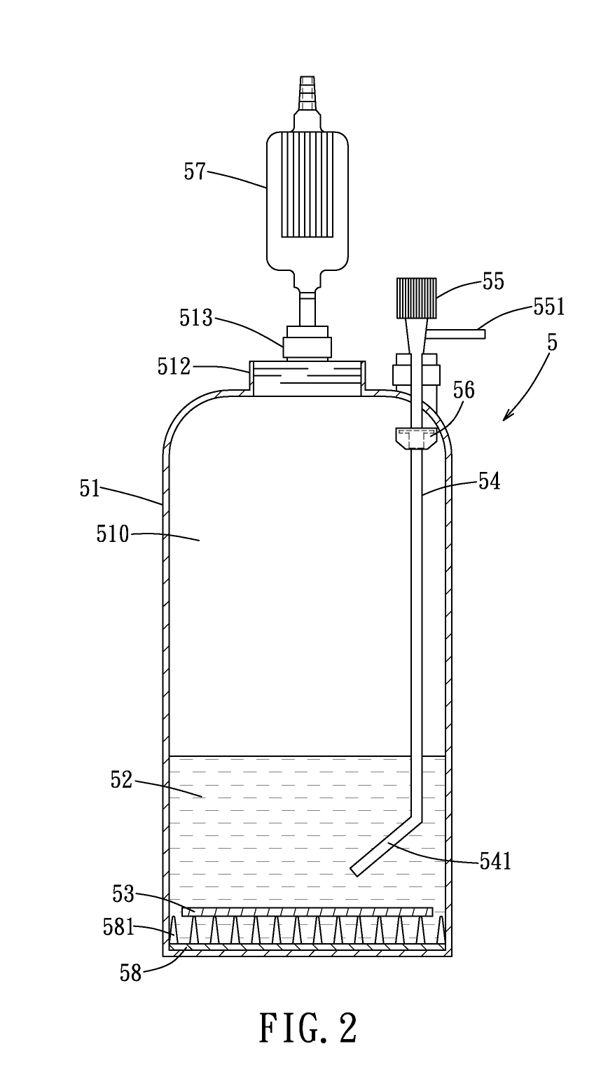

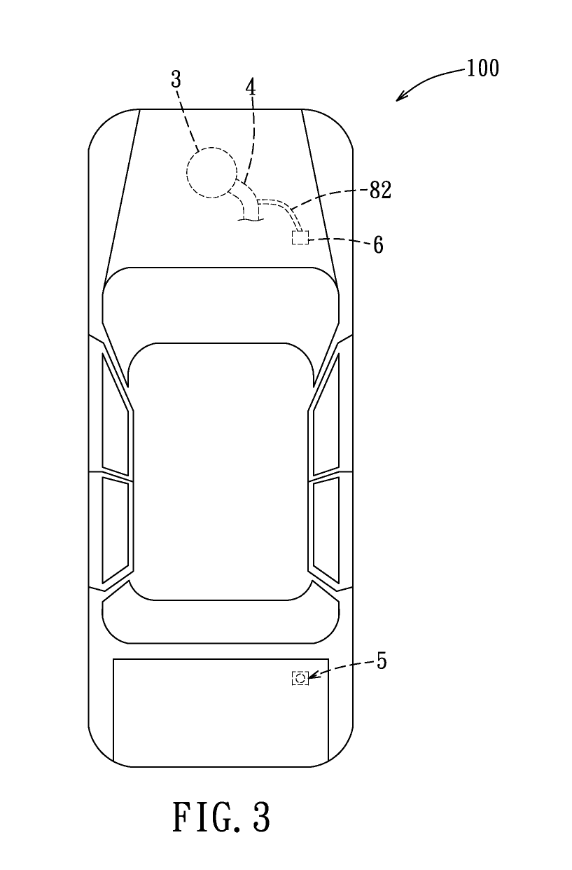

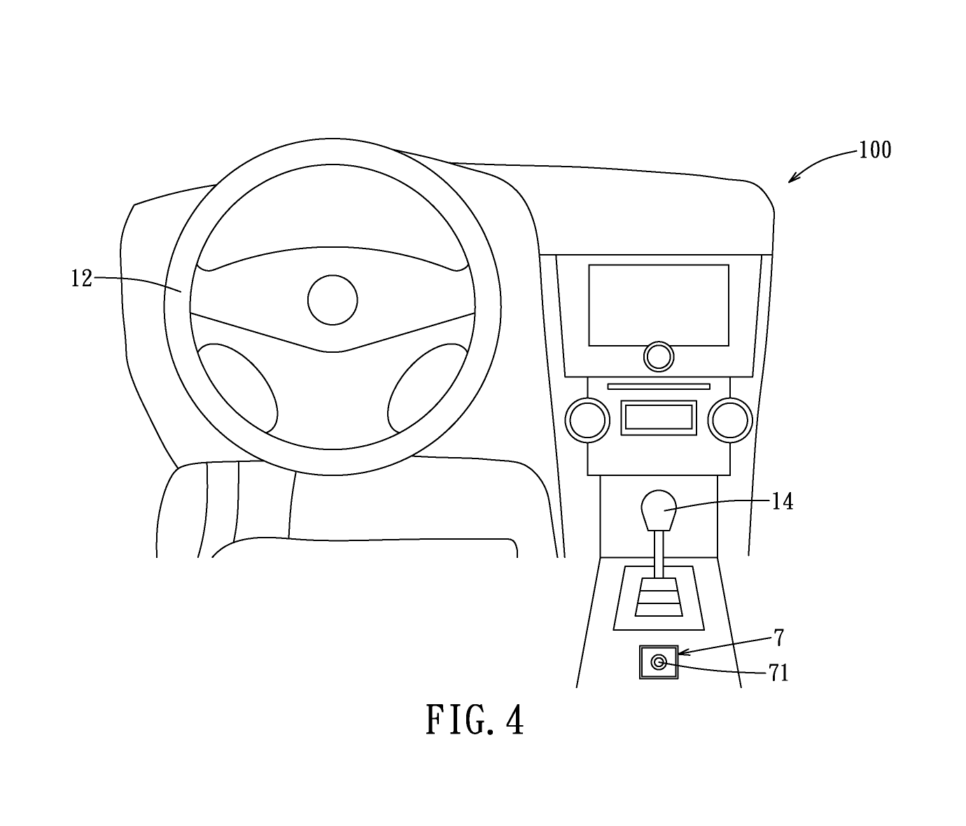

FIGS. 1 to 4 illustrate the preferred embodiment of a hydrogen assisted combustion engine system 200 for a motor vehicle 100 according to the present invention.

The hydrogen assisted combustion engine system 200 includes: an engine 2 having an intake 21; an air filter 3; an inlet duct 4 interconnecting the intake 21 and the air filter 3; a throttle valve 41 disposed in the inlet duct 4 between the intake 21 and the air filter 3; a hydrogen generator 5 for generating a hydrogen-containing gas; a pump 6 connected to the hydrogen generator 5 and the inlet duct 4 for pumping the hydrogen-containing gas from the hydrogen generator 5 into the inlet duct 4; and a speed controller 7 electrically connected to the pump 6 and manually operative for adjusting a speed of the pump 6 so as to permit adjustment of an amount of the hydrogen-containing gas from the hydrogen generator 5 into the inlet duct 4 when the motor vehicle 100 is driven to move.

The hydrogen generator 5 includes a container 51, a body of an aqueous solution 52, a hydro-reactive material 53, a bubble-generating tube 54 extending into the container 51, a gas regulator valve 55 coupled to the bubble-generating tube 54, an air inlet tube 551 connected to the bubble-generating tube 54 through the gas regulator valve 55, a first check valve 56 disposed in the container 51 and coupled to the bubble-generating tube 54, a gas-liquid separator 57, and a support 58 disposed on a bottom of the container 51 and having a plurality of separated supporting pillars 581. The container 51 defines an enclosed inner space 510 therein, and has a gas outlet port 512 connected to the pump 6 for passage of the hydrogen-containing gas therethrough when the pump 6 is actuated. A second check valve 513 is disposed between and is connected to the gas outlet port 512 and the gas-liquid separator 57. The gas-liquid separator 57 is connected to an inlet 61 of the pump through a first connecting tube 81. The aqueous solution 52 is stored in the enclosed inner space 510. The support 58 is immersed in the aqueous solution 52.

The hydro-reactive material 53 is disposed in the aqueous solution 52, is supported on the supporting pillars 581 of the support 58, and is reactive with the aqueous solution 52 to produce hydrogen. Preferably, the hydro-reactive material 53 is selected from magnesium, aluminum, and alloys thereof.

The aqueous solution 52 contains water, an alcohol, such as methanol and ethanol, and an acid, such as hydrochloric acid. Preferably, the aqueous solution 52 contains 20 to 60 wt % of the alcohol, 3 to 9 wt % of the acid, and the remaining is water. In one embodiment, the hydro-reactive material 53 is a porous body of magnesium, and the aqueous solution 52 contains 51 wt % of water, 40 wt % of methanol, and 9 wt % of hydrochloric acid.

In one preferred embodiment, the container 51 is made from a plastic material and has a volume of about 1.5 liters, the aqueous solution 52 is in an amount of about 0.5 liter, and the hydro-reactive material 53 has a size of 4 cm×3 cm×1 cm.

The bubble-generating tube 54 extends into the enclosed inner space 510, and has a bottom end portion 541 disposed in the aqueous solution 52. Accordingly, when the pump 6 is activated, atmospheric air can be drawn into the aqueous solution 52 through the air inlet tube 551 and the bubble-generating tube 54 to generate air bubbles in the aqueous solution 52 so as to provide a stirring effect on the aqueous solution 52 and to mix with the hydrogen produced in the enclosed inner space 510 to form the hydrogen-containing gas. It is noted that the reaction between the hydro-reactive material 53 and the aqueous solution 52 becomes relatively slow when there is no air bubble introduced into the aqueous solution 52, which results in insufficient generation of the hydrogen for supplying to the engine 2. In addition, the air bubbles thus formed serve as a carrier gas that carries the hydrogen formed in the aqueous solution 52 into the enclosed inner space 510 above a surface of the aqueous solution 52. If the bubble-generating tube 54 is not installed or is not extended into the aqueous solution 52, the atmospheric air can be drawn out of the container 51 immediately after it enters the container 51 upon actuation of the pump 6 and only a very small amount of the hydrogen formed in the aqueous solution can be carried out. As such, not only is the generation of hydrogen reduced, delivery of the hydrogen into the engine 2 is also undesirably decreased.

The gas regulator valve 55 is adjustable to regulate a flow rate of the atmospheric air flowing into the bubble-generating tube 54 so as to obtain a suitable flow rate of the atmospheric air and to ensure stable generation of the hydrogen-containing gas with a suitable hydrogen concentration in the hydrogen generator 5. By way of example, it was found in one experiment that when the introduced atmospheric air flowing through the bubble-generating tube 54 was controlled to have a flow rate of about 3 liters per minute while driving the motor vehicle 100 on mountain road, a reduction of gasoline consumption by 20% was achieved.

Since the hydrogen-containing gas may carry liquid droplets therewith when drawn from the hydrogen generator 5, it is desirable to use the gas-liquid separator 57 to separate the hydrogen-containing gas from the liquid droplets. The separated liquid droplets are subsequently recycled into the container 51.

The pump 6 further has an outlet 62 that is connected to the inlet duct 4 through a second connecting tube 82 and a tube fitting 83 so as to deliver the hydrogen-containing gas into the inlet duct 4. The tube fitting 83 is provided on the inlet duct 4 and is disposed between the air filter 3 and the throttle valve 41. The second connecting tube 82 interconnects the outlet 62 of the pump 6 and the tube fitting 83.

The speed controller 7 preferably has a control circuit (not shown) capable of varying an input current to the pump 6, and an operation knob 71 for manually adjusting the input current so as to adjust the speed of the pump 6. Hence, with the inclusion of the pump 6 and the speed controller 7 in the hydrogen assisted combustion engine system 200 of this invention, the amount of the hydrogen-containing gas drawn from the hydrogen generator 5 into the engine 2 to assist combustion of a gasoline fuel in the engine 2 can be controlled.

Preferably, the hydrogen generator 5 is disposed at a rear side of the motor vehicle 100, the pump 6 is disposed at a front side of the motor vehicle 100 adjacent to the inlet duct 4, and the speed controller 7 can be disposed in the motor vehicle 100 adjacent to a steering handle 12 and/or a gearshift lever 14 of the motor vehicle 100 so that it can be accessed by a driver of the motor vehicle 100 for changing the speed of the pump 6.

The assembly of the hydrogen generator 5, the pump 6, the speed controller 7 and the first and second connecting tubes 81, 82 is advantageous in that the same can be readily connected to an engine, a throttle valve, an air filter and an inlet duct of an existing motor vehicle without changing the structure and the operating principle of the existing motor vehicle. The Applicant found that since the existing motor vehicle has a brake system designed for an engine that is fueled with gasoline without assistance of the hydrogen-containing gas, it can cause difficulty in braking the motor vehicle or requirement of an increased stopping distance during driving downhill when the engine is fueled with gasoline and the hydrogen-containing gas (the combustion of which generates a higher output power due to a higher release heat value for the combustion of the hydrogen-containing gas and enables complete combustion of gasoline by the assistance of the hydrogen-containing gas). Hence, inclusion of the speed controller 7 in the hydrogen assisted combustion engine system 200 is essential to prevent the aforementioned difficulty in braking or requirement of an increased stopping distance.

With the inclusion of the pump 6 in the hydrogen assisted combustion engine system 200 of the present invention, stable generation of the hydrogen-containing gas can be achieved. Moreover, with the inclusion of the speed controller 7 in the hydrogen assisted combustion engine system 200 of the present invention, the speed of the pump 6 and thus the amount of the hydrogen-containing gas entering the engine 2 can be controlled, thereby preventing the braking difficulty or requirement of an increased stopping distance when the motor vehicle 100 is driven to move downhill.

With the invention thus explained, it is apparent that various modifications and variations can be made without departing from the spirit of the present invention.

What is claimed is:

1. A hydrogen assisted combustion engine system for a motor vehicle, comprising:
an engine having an intake;
an air filter;
an inlet duct interconnecting said intake and said air filter;
a throttle valve disposed in said inlet duct between said intake and said air filter;
a hydrogen generator for generating a hydrogen-containing gas;
a pump connected to said hydrogen generator and said inlet duct for pumping the hydrogen-containing gas from said hydrogen generator into said inlet duct; and
a speed controller electrically connected to said pump and manually operative for adjusting a speed of said pump so as to permit adjustment of an amount of the hydrogen-containing gas from said hydrogen generator into said inlet duct when the motor vehicle is driven to move.

2. The hydrogen assisted combustion engine system of claim 1, wherein said hydrogen generator includes a container, a body of an aqueous solution, and a hydro-reactive material, said container defining an enclosed inner space therein and having a gas outlet port connected to said pump for passage of the hydrogen-containing gas the re through when said pump is actuated, said aqueous solution being stored in said enclosed inner space, said hydro-reactive material being disposed in said aqueous solution and being reactive with said aqueous solution to produce hydrogen.

3. The hydrogen assisted combustion engine system of claim 2, wherein said hydrogen generator further includes:
a bubble-generating tube being connected to said container, extending into said enclosed inner space, and having a bottom end disposed in said aqueous solution so that when said pump is activated, atmospheric air can be drawn into said aqueous solution through said bubble-generating tube to generate a stirring effect on said aqueous solution and to mix with the hydrogen produced in said enclosed inner space to form the hydrogen-containing gas; and
a gas regulator valve coupled to said bubble-generating tube and being adjustable to regulate a flow rate of the atmospheric air flowing into said bubble-generating tube so as to ensure stable generation of the hydrogen-containing gas from said hydrogen generator.

4. The hydrogen assisted combustion engine system of claim 2, wherein said hydro-reactive material is selected from magnesium, aluminum, and alloys thereof.

5. The hydrogen assisted combustion engine system of claim 4, wherein said hydro-reactive material is magnesium.

6. The hydrogen assisted combustion engine system of claim 2, wherein said aqueous solution contains water, an alcohol, and an acid.

7. The hydrogen assisted combustion engine system of claim 1, further comprising a connecting tube and a tube fitting provided on said inlet duct and disposed between said air filter and said throttle valve, said connecting tube interconnecting said pump and said tube fitting.
